(19) United States
(12) Patent Application Publication
(10) Pub. No.: US 2025/0344236 A1
(43) Pub. Date: Nov. 6, 2025

(54) SYSTEM AND METHOD FOR VERIFICATION TESTING OF CELLS

(71) Applicant: JIO PLATFORMS LIMITED, Ahmedabad, Gujarat (IN)

(72) Inventors: Aayush BHATNAGAR, Navi Mumbai, Maharashtra (IN); Pradeep Kumar BHATNAGAR, Navi Mumbai, Maharashtra (IN); Manoj SHETTY, Mumbai, Maharashtra (IN); Dharmesh A CHITALIYA, Dist - Thane, Maharashtra (IN); Hanumant KADAM, Mumbai, Maharahstra (IN); Sneha VIRKAR, Mumbai, Maharashtra (IN); Neelabh KRISHNA, Gurugram, Haryana (IN); Anshul KOTHARI, Banswara, Rajasthan (IN); Nilesh KHANCHADANI, Madhya Pradesh (IN); Brijesh SHAH, Navi Mumbai, Marahstra (IN); Nitesh Kumar CHOURASIA, Thane, Maharashtra (IN); Mayank TARAN, Thane, Maharashtra (IN)

(73) Assignee: JIO PLATFORMS LIMITED, Ahmedabad, Gujarat (IN)

(21) Appl. No.: 18/993,355

(22) PCT Filed: May 23, 2024
(86) PCT No.: PCT/IN2024/050601

§ 371 Date: Jan. 10, 2025

(30) Foreign Application Priority Data
Jun. 29, 2023 (IN) 202321043758

(51) Int. Cl. H04W 72/542; H04L 41/0823; H04L 41/5009; H04W 24/08

(52) U.S. Cl. CPC H04W 72/542; H04L 41/0823; H04L 41/5009; H04W 24/08

(57) ABSTRACT

The present invention discloses a method (600) for verification testing of cells in a network (106). The method (600) comprising identifying (602) at least one cell added to a database (210) of the network (106), identifying (604) a plurality of neighboring cells associated with the at least one cell, and obtaining (606) a set of parameters for the at least one cell and each of the plurality of neighboring cells from the database (210). The method (600) comprising determining (608) if the set of parameters meets a predefined criterion. When the set of parameters fail to meet the predefined criterion, performing following steps identifying (610), among the at least one cell and the plurality of neighboring cells, a first cell lacking a predefined set of configurations and modifying (612) a current set of configurations of the first cell based on the predefined set of configurations.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to the field of telecommunications. More particularly, the present disclosure relates to a system and a method to perform automated testing on new cells.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Conventional manual verification methods for network elements, including macro cells, small cells, and bi-sector antennas, the process involves extensive manual intervention and verification. This approach requires network engineers and technicians to manually configure and test each individual network element, ensuring its proper functioning and adherence to predefined parameters. These manual verification methods of network elements are a time-intensive process. Each element requires individual attention and configuration, leading to delays in network deployment and optimization. The need for manual intervention at every step significantly slows down the overall verification process. Also, manual verification methods heavily rely on human operators, making it susceptible to human error. Mistakes in configuration, parameter settings, or data analysis can lead to inaccuracies and compromised network performance. The complexity of network configurations increases the likelihood of errors during the manual verification process. These methods lack consistency across different network elements. As each element is verified individually by different operators, there is a risk of inconsistent approaches, resulting in variations in performance and configuration. This inconsistency can impact overall network efficiency and reliability.

Further, these methods become increasingly challenging and resource-intensive as the network expands. With the proliferation of network elements, the number of configurations and tests required grows exponentially, and network engineers and technicians spend substantial time and effort on repetitive tasks, leading to increased operational costs. The need for skilled personnel to perform manual verification further adds to the overall expenses.

There is, therefore, a need in the art to provide a system and a method that can mitigate the problems associated with the prior arts.

### DEFINITION

As used in the present disclosure, the following terms are generally intended to have the meaning as set forth below, except to the extent that the context in which they are used to indicate otherwise.

The term RET as used herein, refers to remote electrical tilt. The RET allows to adjust the electrical tilt of an antenna remotely. The RET is mainly used for mobile radio antennas, for example to optimise the alignment of the mobile radio network at hotspots like events.

The term RRC as used herein, refers to radio resource control protocol. The RRC protocol is used in UMTS, LTE and 5G on the Air interface. It is a layer 3 (Network Layer) protocol used between a user equipment (UE) and a base station.

The term CQI as used herein, refers to channel quality indicator. the CQI is a key parameter in communication system design that encodes the state of the channel. With this information, a base station can adjust the quality of service that would best suit the channel at that time and place, thereby facilitating communications.

### OBJECTS OF THE INVENTION

It is an object of the present disclosure to provide a system and a method that enables in-depth analysis of Performance Management Key Performance Indicators (PM KPIs) and optimization of Remote Electrical Tilt (RET), and this integration enhances the system's ability to identify and address discrepancies, leading to improved network performance.

It is an object of the present disclosure to provide a system and a method that utilizes advanced techniques to examine PM KPIs, allowing for a streamlined verification process, and by automating the analysis of these indicators, the system efficiently identifies any issues or deviations in the network elements, reducing the need for manual intervention.

It is an object of the present disclosure to provide a system and a method that leverages advanced techniques to fine-tune the tilt angle of antennas remotely, resulting in enhanced network coverage and capacity to ensure optimal performance of the newly deployed network elements.

It is an object of the present disclosure to provide a system and a method that improves the efficiency and effectiveness of network operations, reduces the reliance on human operators, minimizes errors, and maximizes overall network performance.

It is an object of the present disclosure to provide a system and a method that saves time, reduces labour costs, and increases operational efficiency, leading to cost savings for the organization.

It is an object of the present disclosure to provide a system and a method that eliminates manual intervention. The system minimizes the risk of human error and inconsistencies, resulting in more precise and reliable network verification.

It is an object of the present disclosure to provide a system and a method that accelerates the network rollout process, reducing delays and improving time-to-market for new network elements.

### SUMMARY

In an exemplary embodiment, the present invention discloses a method for verification testing of cells in a network. The method comprising identifying at least one cell added to a database of the network, identifying a plurality of neighboring cells associated with the at least one cell, and obtaining a set of parameters for the at least one cell and each of the plurality of neighboring cells from the database. The method comprising determining if the set of parameters meets a predefined criterion. When the set of parameters fail to meet the predefined criterion, performing following steps identifying among the at least one cell and the plurality of neighboring cells, a first cell lacking a predefined set of configurations and modifying a current set of configurations of the first cell based on the predefined set of configurations.

In some embodiments, the set of parameters include one or more of a session setup success rate, a radio resource control (RRC) connection success rate, and an average received channel quality indicator (CQI). In some embodiments, method comprising communicating an alert to a network operator when the set of parameters meets the predefined criterion. In some embodiments, method comprising updating a status of the at least one cell in a performance report of the network. In some embodiments, the at least one cell belongs to one of following type: a macro cell, a small cell, or a bi-sector antenna. In some embodiments, the predefined criterion depends on the type of the at least one cell. In some embodiments, the at least one cell and the plurality of neighboring cells belong to a same frequency band. In some embodiments, method comprising determining if the at least one cell and the plurality of neighboring cells fulfil a set of network conditions. In some embodiments, the set of network conditions includes a network availability and the set of parameters availability of the least one cell and each of the plurality of neighboring cells in the network. In some embodiments, the set of parameters availability is estimated from at least one day before the at least one cell is added to the network and at least one day after the at least one cell is added to the network. In some embodiments, the predefined set of configurations include one or more of remote electrical tilt (RET) parameters or handover parameters related to the first cell. In some embodiments, method comprising optimizing a performance of the network based on the modified current configurations of the first cell.

In an exemplary embodiment, the present invention discloses a system for verification testing of cells in a network. The system comprising an identification module in a verification testing engine. The identification module is configured to identify at least one cell added to a database of the network and identify a plurality of neighboring cells associated with the at least one cell. The system comprising a processing module in the verification testing engine, the processing module is configured to obtain a set of parameters for the at least one cell and each of the plurality of neighboring cells from the database and determine if the set of parameters meets a predefined criterion. When the set of parameters fail to meet the predefined criterion, the processing module is configured to identify, among the at least one cell and the plurality of neighboring cells, a first cell lacking a predefined set of configurations and modify a current set of configurations of the first cell based on the predefined set of configurations.

In some embodiments, the set of parameters include one or more of a session setup success rate, a RRC connection success rate, and an average received CQI. In some embodiments, system is configured to communicate an alert to a network operator when the set of parameters meets the predefined criterion. In some embodiments, the system is configured to update the status of at least one cell in a performance report of the network. In some embodiments, the at least one cell belongs to one of following type: a macro cell, a small cell, or a bi-sector antenna. In some embodiments, the predefined criterion depends on the type of the at least one cell. In some embodiments, the at least one cell and the plurality of neighboring cells belong to a same frequency band. In some embodiments, the system is configured to determine if at least one cell and the plurality of neighboring cells fulfil a set of network conditions. In some embodiments, the set of network conditions includes a network availability and the set of parameters availability of the least one cell and each of the plurality of neighboring cells in the network. In some embodiments, the set of parameters availability is estimated from at least one day before the at least one cell is added to the network and at least one day after the at least one cell is added to the network. In some embodiments, the predefined set of configurations includes one or more remote electrical tilt (RET) parameters or handover parameters related to the first cell. In some embodiments, the system is configured to optimize the performance of the network based on the modified current configurations of the first cell.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture (100) for implementing a proposed system (108), in accordance with an embodiment of the present disclosure.

FIG. 2 illustrates an example block diagram of a proposed system (108), in accordance with an embodiment of the present disclosure.

FIG. 3 illustrates an exemplary method for performing verification test, in accordance with an embodiment of the present disclosure.

FIGS. 4A and 4B illustrate exemplary flowcharts for verification testing on cells, in accordance with an embodiment of the present disclosure.

FIG. 5 illustrates an example computer system in which or with which the embodiments of the present disclosure may be implemented.

FIG. 6 illustrates an exemplary flow chart of a method for verification testing of cells in a network, in accordance with an embodiment of the present disclosure.

The foregoing shall be more apparent from the following more detailed description of the disclosure.

### LIST OF REFERENCE NUMERALS

100—Network architecture
200—Block Diagram
202—Processor(s)
204—Memory
206—Interface(s)
208—Identification module
210—Database
212—Verification testing engine
214—Processing module
300—Flow diagram
400—Flow diagram
500—A computer system
510—External storage device
520—Bus
530—Main memory
540—Read only memory
550—Mass storage device
560—Communication port(s)
600—Flow diagram

### DETAILED DESCRIPTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

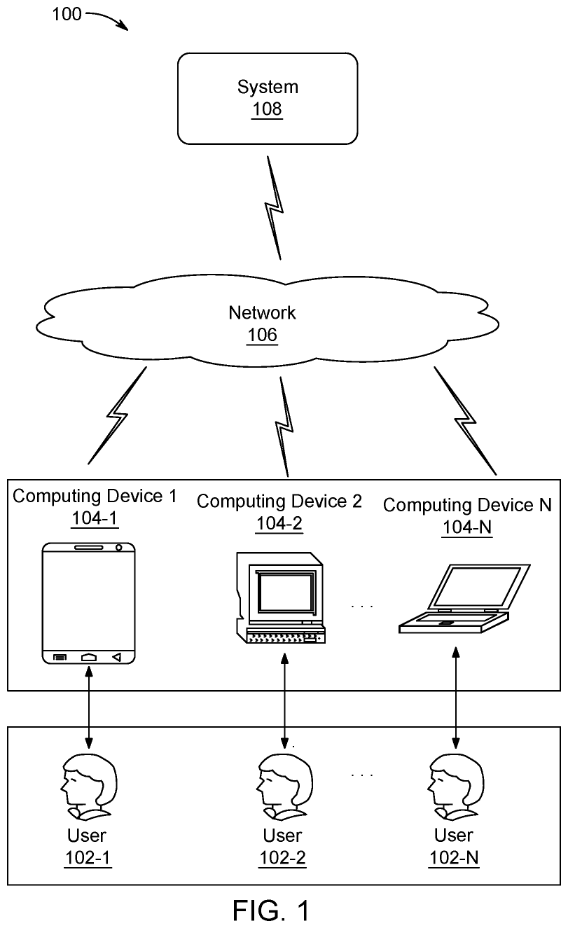

The various embodiments throughout the disclosure will be explained in more detail with reference to FIGS. 1-5.

FIG. 1 illustrates an example network architecture (100) for implementing a system (108), in accordance with an embodiment of the present disclosure.

As illustrated in FIG. 1, a system (108) that eliminates the requirement for manual verification of recently added Macro cells, Small Cells, and Bi-Sector antennas is disclosed. The system (108) entails integrating advanced techniques that analyzes Performance Management Key Performance Indicators (PM KPIs) and offer optimization solutions for Remote Electrical Tilt (RET). One or more computing devices (104-1, 104-2 . . . 104-N) may be connected to the system (108) through a network (106). A person of ordinary skill in the art will understand that one or more computing devices (104-1, 104-2 . . . 104-N) may be collectively referred to as computing devices (104) and individually referred to as computing devices (104). One or more users (102-1, 102-2 . . . 102-N) may provide one or more requests to the system (108). A person of ordinary skill in the art will understand that one or more users (102-1, 102-2 . . . 102-N) may be collectively referred to as users (102) and individually referred to as users (102). Further, the computing devices (104) may also be referred to as user equipment (UE) (104) or as UEs (104) throughout the disclosure.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102), such as a touchpad, touch-enabled screen, electronic pen, and the like, may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof

In an embodiment, the system (108) may be configured to identify a first cell, among the new cell and its neighboring cells, that lacks a pre-set configuration, and the identification is performed by comparing a set of parameters (session setup success rate, RRC connection success rate, average received CQI, etc.) of each cell with a predefined criterion that vary based on the cell type (macro, small, or bisector), i.e. XCVT. The XCVT refers to the overall concept of verification testing, including SCVT (Small Cell Verification Testing), MCVT (Macro Cell Verification Testing), and BSA SCVT (Bi-Sector Antenna Small Cell Verification Testing).

In an embodiment, the system (108) may be configured to determine that the first cell when fails to meet a predefined criterion in terms of the set of parameters, indicates the absence of a pre-set configuration.

In an embodiment, the system (108) may be configured to identify a second cell, selected from the first cell and its neighboring cells, for which a set of configurations (e.g., RET parameters and handover parameters) requires modification.

In an embodiment, the system (108) may be configured to modify a current set of configurations associated with the second cell, enabling optimization and configuration adjustments.

In an embodiment, the system (108) emphasizes cost reduction and operational efficiency by automating the verification process. This automation leads to faster outcomes, improved precision, and reduced errors, resulting in enhanced operational efficiency and cost savings. Additionally, the system (108) demonstrated significant business relevance by saving a substantial number of man-hours during the 4G rollout. They also offer a technology-agnostic approach, ensuring seamless adaptation to future wireless technologies like 5G and 6G, thus providing long-term value and cost savings. Further, integration of automation and intelligence within the modules contributes to streamlined network rollout and optimization. By minimizing errors and delays through automated processes, the project timelines and budgets are positively impacted.

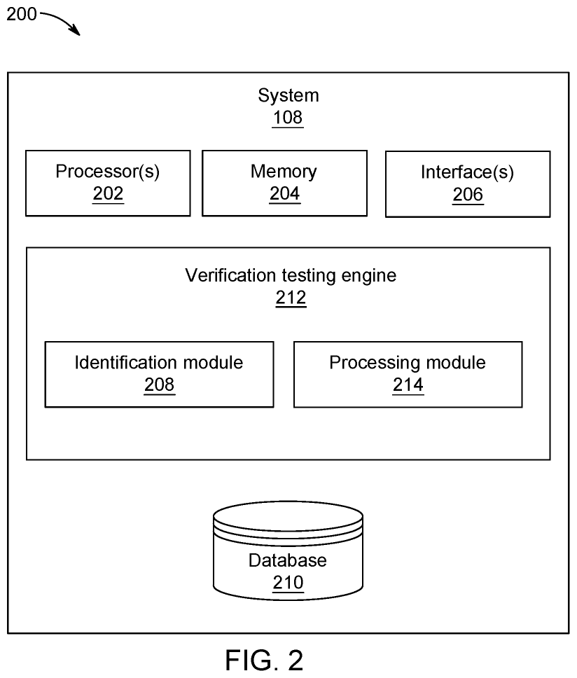

FIG. 2 illustrates an example block diagram (200) of a system (108), in accordance with an embodiment of the present disclosure.

Referring to FIG. 2, in an embodiment, the system (108) may include one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output devices (I/O), storage devices, and the like. The interface(s) (206) may facilitate communication through the system (108). The interface(s) (206) may also provide a communication pathway for one or more components of the system (108). Examples of such components include, but are not limited to, processing engine(s) (208) and a database (210). Further, the processing engine(s) (208) may include a verification testing engine (212) and other engine(s). In an embodiment, the other engine(s) may include, but are not limited to, a data ingestion engine, an input/output engine, and a notification engine. The database (210) stores the various sets of parameters, a set of predefined configurations associated with the cells in the network.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processor (202) may be configured to performs a verification test for a newly deployed cell that is in close proximity to multiple neighboring cells, by the verification testing engine (212). The verification testing engine (212) comprises an identification module (208) and a processing module (214). The verification testing engine (212) identifies performance management key performance indicators (PM KPIs) and discrepancies or issues related to newly added network elements by performing a comprehensive examination of PM KPIs, providing valuable insights into the network's performance. Also, the verification testing engine (212) compares a set of parameters (such as session setup success rate, RRC connection success rate, average received CQI, etc.) of the new cell and its neighboring cells with predefined criterion. It identifies the first cell that has not been configured with a predefined set of configurations when its parameter values fail to meet the predefined criterion. When the first cell with the improper set of configurations is identified, the verification testing engine (212) determines that it needs to be configured with the appropriate parameters. Further, the verification testing engine (212) identifies a second cell, which can be either the first cell or one of its neighboring cells. This selection is based on the second cell lacking a predefined set of configurations of the parameters (such as RET and handover parameter) associated with the second cell that require modification and also modifies a current set of configurations associated with the second cell, ensuring that they are appropriately configured to optimize its performance.

The verification testing engine (212) optimizes the network's coverage and capacity, the solution offers closed-loop optimization solutions for remote electrical tilt (RET), enabling the adjustment of antenna tilt angles remotely.

In an exemplary embodiment, the present invention discloses a system for verification testing of cells in a network. The system comprising an identification module (208) in a verification testing engine (212). The identification module (208) is configured to identify at least one cell added to a database (210) of the network and identify a plurality of neighboring cells associated with the at least one cell. The system comprising a processing module (214) in the verification testing engine, the processing module (214) is configured to obtain a set of parameters for the at least one cell and each of the plurality of neighboring cells from the database (210) and determine if the set of parameters meets a predefined criterion. When the set of parameters fail to meet the predefined criterion, the processing module (214) is configured to identify, among the at least one cell and the plurality of neighboring cells, a first cell lacking a predefined set of configurations and modify a current set of configurations of the first cell based on the predefined set of configurations.

In some embodiments, the set of parameters include one or more of a session setup success rate, a radio resource control (RRC) connection success rate, and an average received channel quality indicator (CQI). In some embodiments, system is configured to communicate an alert to a network operator when the set of parameters meets the predefined criterion. In some embodiments, system is configured to update a status of the at least one cell in a performance report of the network. In some embodiments, the at least one cell belongs to one of following type: a macro cell, a small cell, or a bi-sector antenna. In some embodiments, the predefined criterion depends on the type of the at least one cell. In some embodiments, the at least one cell and the plurality of neighboring cells belong to a same frequency band. In some embodiments, system is configured to determine if the at least one cell and the plurality of neighboring cells fulfil a set of network conditions. In some embodiments, the set of network conditions includes a network availability and the set of parameters availability of the least one cell and each of the plurality of neighboring cells in the network. In some embodiments, the set of parameters availability is estimated from a predefined time period (for example, at least one day) before the at least one cell is added to the network and a second predefined time period (for example, at least one day) after the at least one cell is added to the network. In some embodiments, the predefined set of configurations include one or more of remote electrical tilt (RET) parameters or handover parameters related to the first cell. In some embodiments, the system is configured to optimize a performance of the network based on the modified current configurations of the first cell. In some embodiments, the predefined criterion includes at least one value corresponding to each parameter.

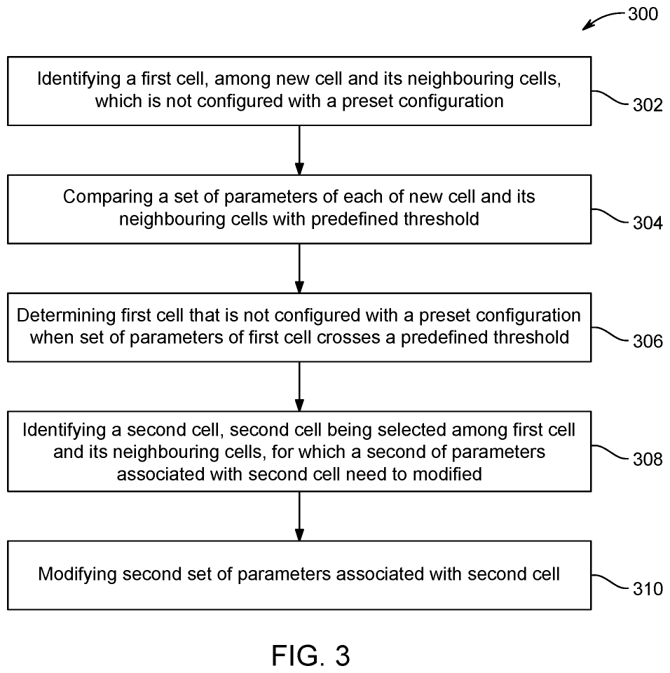

FIG. 3 illustrates an exemplary method (300) for performing verification test, in accordance with an embodiment of the present disclosure.

As illustrated, a method (300) for performing a verification test for a new cell deployed in a location proximity to a plurality of neighboring cells is disclosed.

At block (302), the method (300) includes identifying a first cell, among the new cell and its neighboring cells, which is not configured with a pre-set configuration.

At block (304), the method (300) includes comparing a set of parameters (session setup success rate, RRC connection success rate and average received CQI) of each of the new cell and its neighboring cells with the predefined criterion (the predefined criterion varies with macro, small and bisector cell).

At block (306), the method (300) includes determining the first cell that is not configured with a preset configuration when the set of parameters of the first cell fail to meet a predefined criterion.

At block (308), the method (300) includes identifying a second cell, the second cell being selected (one or in combination) among the first cell and its neighboring cells, for which a second of parameters (RET and handover parameter) associated with the second cell need to be modified.

At block (310), the method (300) includes modifying the second set of parameters associated with the second cell.

In an exemplary embodiment, the present invention discloses a method for verification testing of cells in a network. The method comprising identifying at least one cell added to a database of the network, identifying a plurality of neighboring cells associated with the at least one cell, and obtaining a set of parameters for the at least one cell and each of the plurality of neighboring cells from the database. The method comprising determining if the set of parameters meets a predefined criterion. When the set of parameters fail to meet the predefined criterion, performing following steps identifying among the at least one cell and the plurality of neighboring cells, a first cell lacking a predefined set of configurations and modifying a current set of configurations of the first cell based on the predefined set of configurations.

In some embodiments, the set of parameters include one or more of a session setup success rate, a radio resource control (RRC) connection success rate, and an average received channel quality indicator (CQI). In some embodiments, the method comprises communicating an alert to a network operator when the set of parameters meets the predefined criterion. In some embodiments, the method comprises updating the status of at least one cell in a performance report of the network. In some embodiments, at least one cell belongs to one of the following types: a macro cell, a small cell, or a bi-sector antenna. In some embodiments, the predefined criterion depends on the type of the at least one cell. In some embodiments, the at least one cell and the plurality of neighboring cells belong to a same frequency band. In some embodiments, the method comprises determining if at least one cell and the plurality of neighboring cells fulfil a set of network conditions. In some embodiments, the set of network conditions includes a network availability and the set of parameters availability of the least one cell and each of the plurality of neighboring cells in the network. In some embodiments, the set of parameters availability is estimated from at least one day before the at least one cell is added to the network and at least one day after the at least one cell is added to the network. In some embodiments, the predefined set of configurations includes one or more of remote electrical tilt (RET) parameters or handover parameters related to the first cell. In some embodiments, the method comprises optimizing the performance of the network based on the modified current configurations of the first cell. In some embodiments, the predefined criterion includes at least one value corresponding to each parameter.

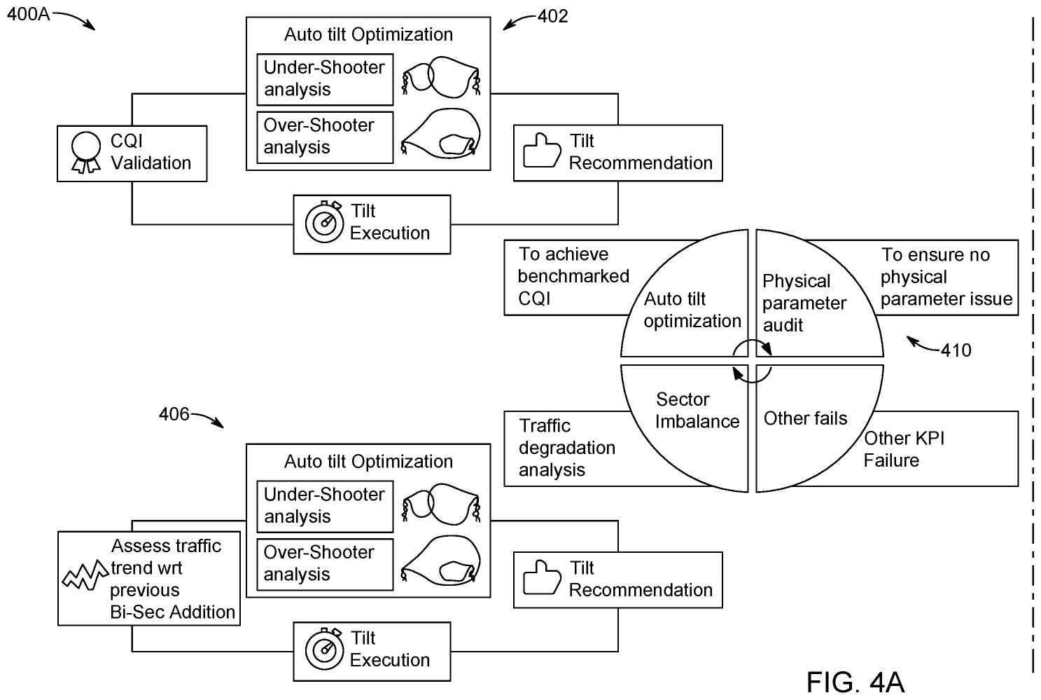

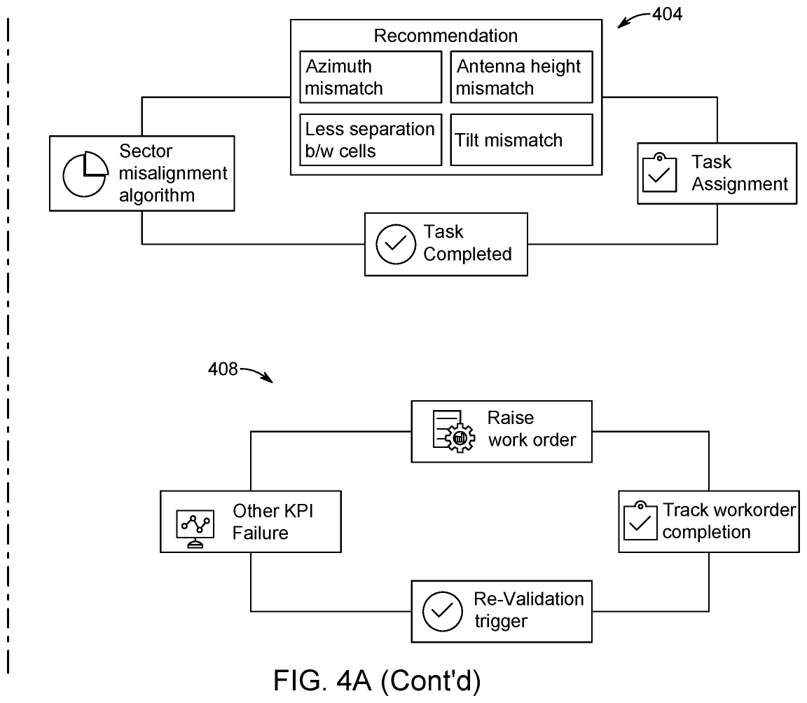

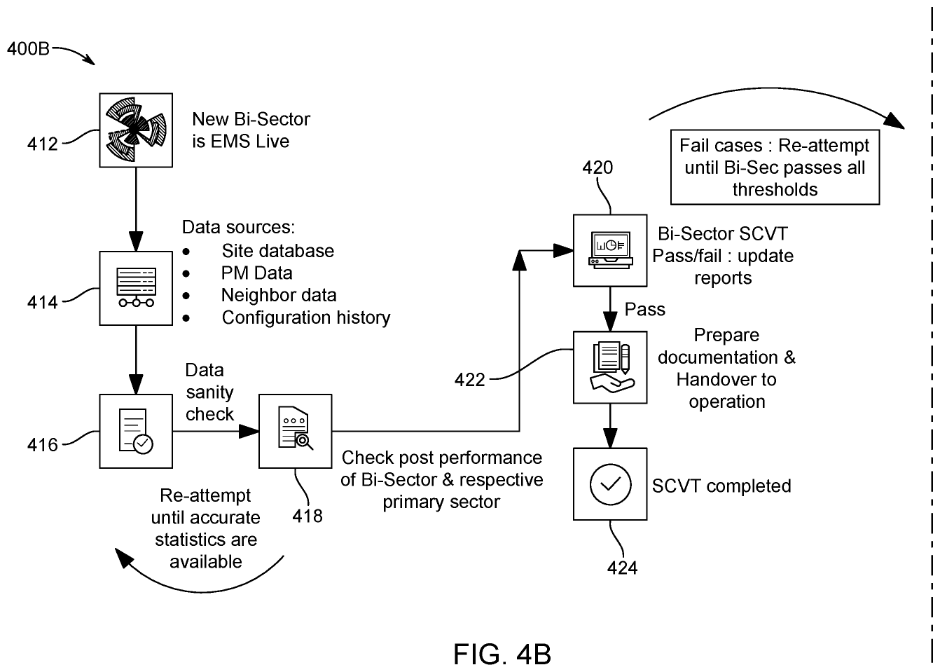

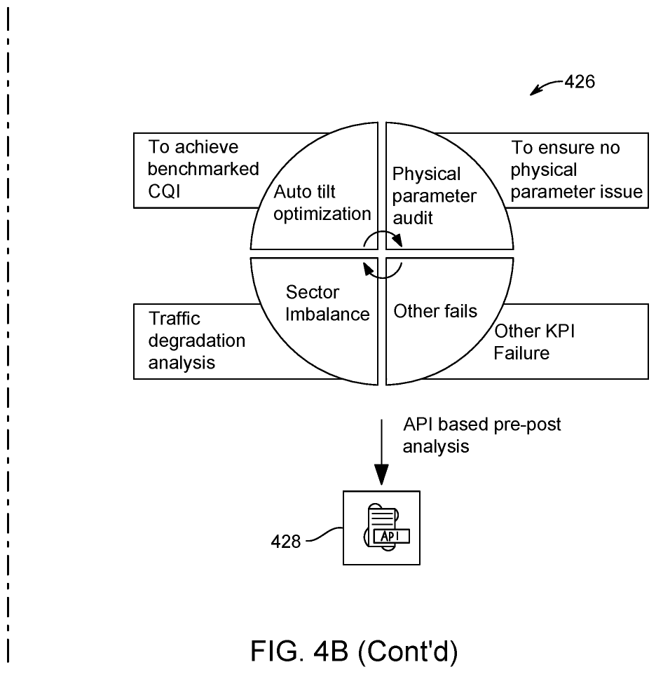

FIGS. 4A and 4B illustrate exemplary flowcharts for verification testing of the network elements (such as macro cells, small cells, and Bi-sector antennas), in accordance with an embodiment of the present disclosure.

As illustrated in FIG. 4A, a flowchart (400A) is disclosed, for automation of verification testing system (108) utilizing auto tilt optimization to achieve benchmarked channel quality indicator (CQI), physical parameter audit to ensure no physical parameter issue, sector imbalance for traffic degradation analysis, and other identify other Key Performance Indicators (KPI) failures.

In wireless communication, especially in cellular networks like 5G,

antennas often need to be tilted or adjusted to optimize coverage and performance. Auto tilt is an automatic electrical tilt (AET), that dynamically adjusts the tilt angle of the antennas based on real-time conditions. This feature is particularly important in modern cellular networks like 5G, where optimizing antenna tilt can significantly improve coverage and capacity. The auto-tilt functionality automates this process by dynamically adjusting the tilt angle of antennas based on various factors such as network load, signal strength, and user density.

At 402, the auto tilt optimization on the antenna is performed. In an aspect, the auto tilt optimization is performed using ‘under-shooter analysis’ or ‘over-shooter analysis’ to generate a tilt recommendation for the antenna. In an aspect, the recommended tilt is executed using the RET. In an aspect, the ‘under-shooter analysis’ assesses situations where the auto-tilt mechanism may not adequately adjust the antenna tilt angle, resulting in suboptimal network performance or coverage gaps. In an aspect, ‘over-shooter analysis’ refers to the examination of situations where the auto-tilt mechanism adjusts the antenna tilt angle (a current set of configurations) excessively, leading to potential negative impacts on network performance or coverage. Further, after the tilt execution, the CQI parameter verification is checked. When it is determined that the CQI parameter fails to meet a predetermined/predefined criterion, the whole process, starting from the auto tilt optimization, is performed again (closed loop). In an aspect, the predefined criterion includes at least one value corresponding to each parameter.

At 404, the sector misalignment technique is performed based on the at least one of the recommendations regarding azimuth mismatch, antenna height mismatch, less separation between cells and tilt mismatch. The at least one of the recommendations regarding the azimuth mismatch, the antenna height mismatch, the less separation between cells, and the tilt mismatch is compared with their respective predetermined criteria. In an aspect, when it is determined that at least one of the recommendations regarding the azimuth mismatch, the antenna height mismatch, the less separation between cells, and the tilt mismatch fail to meet the predetermined criteria a task assignment is generated. In an aspect, the task assignment is completed such that at least one of the recommendations regarding the azimuth mismatch, the antenna height mismatch, the less separation between cells, and the tilt mismatch meet their respective predetermined criteria. In an aspect, the whole process of the sector misalignment technique based on the comparison of the recommendations regarding the azimuth mismatch, the antenna height mismatch, the less separation between cells, and the tilt mismatch with their respective predetermined criteria is performed again (closed loop).

At 406, the auto tilt optimization on the antenna is performed using the under-shooter analysis and the over-shooter analysis to generate a tilt recommendation for the antenna. In an aspect, the recommended tilt is executed using the RET. Further, after the tilt execution, a traffic trend in the network is assessed with respect to a previous bi-sector antenna addition. When it is determined that the traffic trend in the network fails to meet a predetermined criterion. the whole process starting from the auto tilt optimization is performed again (closed loop).

At 408, the other KPIs (e.g., capacity, coverage, etc.) related to the antenna are compared with predefined criteria to find out at least one KPI failure. When it is determined that the at least one KPI fails to meet the predetermined criteria, a work order related to the at least one KPI is generated/raised. The work order completion is tracked from time to time. When the work order gets completed, a re-validation related to the at least one failed KPI is triggered. Further, again the whole process of estimating the KPI failure is performed (in a closed loop).

At 410, the auto tilt optimization is performed to achieve the benchmark CQI. The physical parameter audit is performed to ensure that each physical parameter issue get resolved. The sector imbalance is corrected through traffic degradation analysis and other KPI failures are also checked and corrected. Thus, the present disclosure works as a closed-loop approach to achieve the verification testing on the network elements (such as macro cells, small cells, and Bi-sector antennas).

Further, as shown in FIG. 4B a flowchart (400B) is disclosed, for small cell verification testing (SCVT) automation process, based on performed process documentation is also prepared.

The system (108) incorporates advanced techniques or algorithms to streamline the verification process and eliminate the need for manual intervention. These techniques analyze PM KPIs to gain valuable insights into the network elements' performance. By leveraging this data, the automated solution can identify any discrepancies or issues with the newly added Macro cells, Small Cells, and Bi-Sector antennas. Additionally, the system (108) provides a closed-loop approach for optimizing the RET, which involves adjusting the tilt angle of antennas remotely. By optimizing the tilt angle, the system enhances the network's coverage and capacity, ensuring optimal performance. The integration of these advanced techniques allows the automated solution to determine the most suitable RET configurations for the newly deployed network elements. This optimization process improves their performance while minimizing the need for manual intervention.

At 412, it is checked if at least one new cell is live via Element Management Systems (EMS) in a master database (DB). In an aspect, the SCVT for the at least one cell is triggered when an EMS_Live date of the at least one cell is ‘Z’ days before the master DB gets updated. In an aspect, it is determined if the at least one cell is a primary sector cell or a bi-sector cell. When the at least one cell is a bi-sector cell, then it is determined if the EMS Live date of the at least one cell is within ±‘M’ days with respect to the live date of the available primary sector cells in the network. When it is determined that the EMS Live date of the at least one cell is not within ±‘M’ days with respect to the live date of the primary sector cells, then a Bi-sector automation process is for the at least one cell performed. When it is determined that the EMS Live date of the at least one cell is within ±‘M’ days with respect to the live date of the primary sector cells, then 1^{st} tier physical neighbors (e.g., close physical proximity to the at least one cell) as well as neighbors based on a ‘High rank neighbor report’ generated by the network on the date of EMS_Live of the at least one cell (e.g., neighboring cells with a high rank or priority) are listed down. In an aspect, only same band neighbors related to the at least one cell is considered for the SCVT. In an aspect, it is ensured that the pre and post date is the same for all the cells of a specific band. The pre and post-date refer to the dates before and after the installation of at least one cell in the network. The pre and post data refers to the KPI data before and after the installation of the at least one cell in the network. In an aspect, the number of days (‘X’ days) for which the pre and post data is required may be user defined. In an aspect, the neighbors (e.g., top ten neighbors) whose KPI data is available on one or more days out of ‘X’ days are picked for the SCVT of the at least one cell.

In an aspect, for the SCVT to get performed, the at least one cell is required to meet some network conditions. For example, the at least one cell and each of the neighboring cells are checked for a minimum radio access network (RAN) availability. Further, it is checked if the KPI data related to the at least one cell is reported for the most recent ‘X’ days (both on the predate and the post date of the installation of the at least one cell) or not. In an aspect, it is checked that on each of the ‘X’ days, all KPI data for ‘p %’ (e.g., 80%) of the total identified neighbors is available or not. For example, it may happen that for a neighbor, the KPI data is available only for one day, two days or three days.

At 414, the various data sources for the KPI data related to the at least one cell and the top neighbor cells comprise site database, the PM KPI data, the neighbor data and the configuration history.

At 416, data sanity check is performed. The data sanity checks the quality, accuracy, and reliability of the KPI data used for analysis, and decision-making. Ensuring data sanity involves validating and verifying that the KPI data is consistent, complete, and free from errors or anomalies that could lead to incorrect conclusions or actions. At 418, a re-attempt is made until accurate statistics related to the KPI data is available from the data sanity check. In an aspect, the post-performance of at least one cell (bi-sector cell) and the respective top neighbors (primary sector cells) are checked when the predefined conditions are met. In an aspect, the pre and post KPI data associated with the at least one cell and the top neighbors may get obtained and the KPIs are assessed against a predefined criterion. For example, the KPIs are compared against respective threshold values obtained from the KPI data (PM KPI data).

At 420, when the KPIs meet the predefined criteria, the at least one cell is considered as ‘Pass’ for the SCVT and a SCVT report (network report) is updated with ‘Pass’ remarks. In an aspect, when the KPIs fail to meet the predefined criteria, the at least one cell is considered as ‘Fail’ for the SCVT and the SCVT report is updated with ‘Fail’ remarks. In an aspect, a re-attempt is made unit the at least one fail cell meet the predefined criteria (passes all the threshold values).

At 422, when the at least one cell is considered as ‘Pass’ for the SCVT and the SCVT report is updated with ‘Pass’ remarks, a documentation is prepared, and a handover is made for further analysis (e.g., to operations team). In an aspect, the further analysis may comprise of 360-degree evaluation analysis of the at least one cell based on the KPI data.

At 424, the SVCT of the at least one cell is considered as completed.

At 426, the auto tilt optimization of the at least one cell is performed to achieve the benchmark CQI. The physical parameter audit is performed to ensure that all the physical parameter issues related to the at least one cell are resolved. The sector imbalance is corrected through traffic degradation analysis and other KP) failures are also checked and corrected. Thus, the present disclosure follows a closed loop approach for performing SVCT of the at least one cell.

At 428, an application programming interface (API) is generated based on the pre and post KPI data analysis related to the at least one cell and the top neighbor cells.

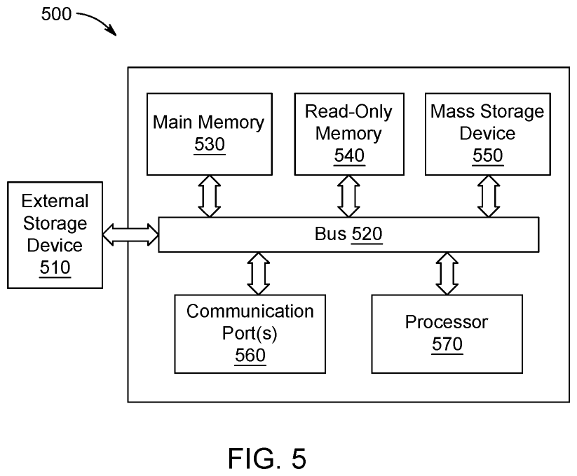

FIG. 5 illustrates an example computer system (500) in which or with which the embodiments of the present disclosure may be implemented.

As shown in FIG. 5, the computer system (500) may include an external storage device (510), a bus (520), a main memory (530), a read-only memory (540), a mass storage device (550), a communication port(s) (560), and a processor (570). A person skilled in the art will appreciate that the computer system (500) may include more than one processor and communication ports. The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (560) may be chosen depending on a network, such as a Local Area Network (LAN), Wide Area Network (WAN), or any network to which the computer system connects.

In an embodiment, the main memory (530) may be Random Access Memory (RAM), or any other dynamic storage device commonly known in the art. The read-only memory (540) may be any static storage device(s) e.g., but not limited to, a Programmable Read Only Memory (PROM) chip for storing static information e.g., start-up or basic input/output system (BIOS) instructions for the processor (570). The mass storage device (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (520) may communicatively couple the processor(s) (970) with the other memory, storage, and communication blocks. The bus (920) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (570) to the computer system (500).

In another embodiment, operator and administrative interfaces, e.g., a display, keyboard, and cursor control device may also be coupled to the bus (520) to support direct operator interaction with the computer system (500). Other operator and administrative interfaces can be provided through network connections connected through the communication port(s) (560). Components described above are meant only to exemplify various possibilities. In no way should the aforementioned exemplary computer system (500) limit the scope of the present disclosure.

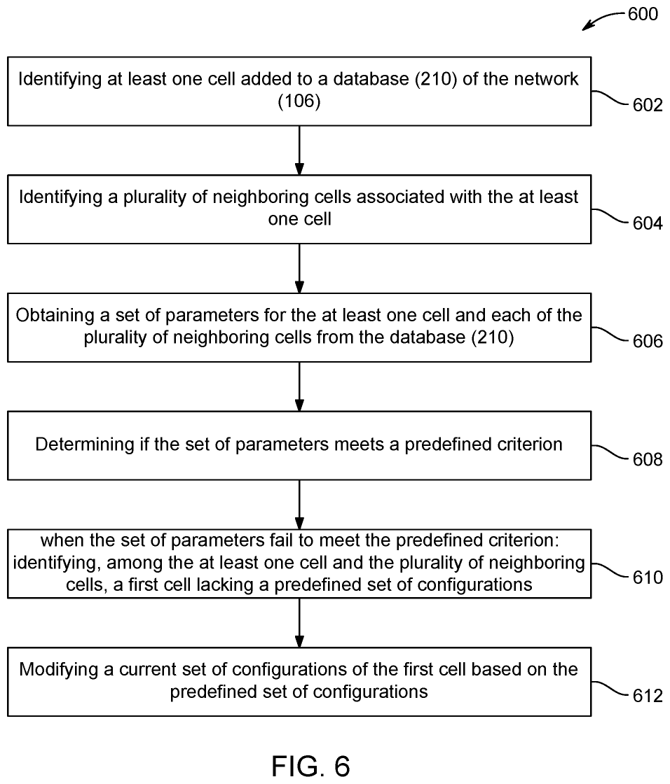

FIG. 6 illustrates an exemplary flow diagram (600) of a method for verification testing of cells in a network, in accordance with an embodiment of the present disclosure.

At step 602, the method comprising identifying at least one cell added to a database of the network.

At step 604, the method comprises identifying a plurality of neighboring cells associated with the at least one cell.

At step 606, the method comprising obtaining a set of parameters for the at least one cell and each of the plurality of neighboring cells from the database.

At step 608, determining if the set of parameters meets a predefined criterion.

At step 610, the method comprising determining a first network cell that is not configured with a predefined set of configurations among the identified plurality of new network cells and the identified plurality of neighboring network cells.

At step 612, when the set of parameters fail to meet the predefined criterion, identifying among the at least one cell and the plurality of neighboring cells, a first cell lacking a predefined set of configurations.

At step 614, modifying a current set of configurations of the first cell based on the predefined set of configurations.

In an aspect, the present invention provides automated solution for verification. The present invention aims to develop an automated solution that eliminates the need for manual verification of recently added network elements, including Macro cells, Small Cells, and Bi-Sector antennas. This automation streamlines the verification process and reduces the need for manual intervention, introducing efficiency and accuracy.

In an aspect, the present invention provides integration of advanced techniques. By incorporating sophisticated techniques, the present invention can analyze Performance Management Key Performance Indicators (PM KPIs) to gain insights into the performance of network elements. This integration allows for a comprehensive examination of PM KPIs and the identification of any discrepancies or issues related to the newly added network elements.

In an aspect, the present invention provides optimization solutions for remote electrical tilt (RET): The present invention offers a closed-loop approach to provide optimization solutions for RET. The closed-loop approach is a technique used to adjust the tilt angle of antennas remotely. By optimizing the tilt angle, the network's coverage and capacity can be enhanced, leading to optimal performance.

In an aspect, the present invention provides cost reduction and operational efficiency. The present invent emphasizes cost-effectiveness by minimizing expenses associated with man-hours and repetitive optimization tasks. By automating the verification process, the present invention achieves faster outcomes, improved precision, and reduced errors, contributing to enhanced operational efficiency and cost savings.

In an aspect, the present invention provides business relevance and versatility. The present invention has demonstrated significant business relevance by saving a substantial number of man-hours during the 4G rollout period. The present invention offers a technology-agnostic approach, enabling seamless adaptation to future wireless technologies like 5G and 6G. This adaptability ensures long-term value and cost savings.

In an aspect, the present invention provides streamlined network rollout and optimization. The integration of automation and intelligence within the present invention contributes to faster and more efficient network rollout and optimization. The present invention provides an automated processes minimize errors and delays, positively impacting project timelines and budgets.

In an aspect, the present invention provides direct impact on the bottom line. The time and cost savings achieved through the utilization of present invention directly impact the organization's bottom line. By optimizing resource utilization, improving operational effectiveness, and embracing technological advancements, the present invention delivers tangible business benefits.

In an aspect, the present invention utilizes harnesses sophisticated techniques to analyze PM KPIs, validate newly added network elements, and provide optimization solutions for RET, ultimately enhancing the efficiency and effectiveness of network operations.

In an aspect, the present invention can be implemented in a 5G and 4G wireless network for optimizing the performance of the network. In an aspect, the present invention provides a versatility for future technologies.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that enables in-depth analysis of Performance Management Key Performance Indicators (PM KPIs) and optimization of Remote Electrical Tilt (RET). By integrating these capabilities, the system becomes more effective in identifying and resolving discrepancies, ultimately leading to improved network performance.

The present disclosure provides a system and a method that utilizes advanced techniques to examine PM KPIs, resulting in a streamlined verification process. By automating the analysis of these indicators, the system efficiently detects any issues or deviations in the network elements, reducing the need for manual intervention.

The present disclosure provides a system and a method that leverages advanced techniques to fine-tune the tilt angle of antennas remotely, leading to enhanced network coverage and capacity. The goal is to ensure optimal performance of the newly deployed network elements.

The present disclosure provides a system and a method that improves the efficiency and effectiveness of network operations while reducing reliance on human operators. By minimizing errors and maximizing overall network performance, the system enhances operational efficiency.

The present disclosure provides a system and a method that saves time, reduces labour costs, and increases operational efficiency, resulting in cost savings for the organization.

The present disclosure provides a system and a method that eliminates manual intervention, thereby minimizing the risk of human error and inconsistencies. As a result, the network verification process becomes more precise and reliable.

The present disclosure provides a system and a method that accelerates the network rollout process, reducing delays and improving time-to-market for new network elements.

We claim:

1. A method (600) for verification testing of cells in a network (106), the method comprising:
identifying (602) at least one cell added to a database (210) of the network (106);
identifying (604) a plurality of neighboring cells associated with the at least one cell;
obtaining (606) a set of parameters for the at least one cell and each of the plurality of neighboring cells from the database (210);
determining (608) if the set of parameters meets a predefined criterion;
when the set of parameters fail to meet the predefined criterion, performing following steps:
identifying (610), among the at least one cell and the plurality of neighboring cells, a first cell lacking a predefined set of configurations; and
modifying (612) a current set of configurations of the first cell based on the predefined set of configurations.

2. The method (600) as claimed in claim 1, wherein the set of parameters include one or more of a session setup success rate, a radio resource control (RRC) connection success rate, and an average received channel quality indicator (CQI).

3. The method (600) as claimed in claim 1, further comprising communicating an alert to a network operator when the set of parameters meets the predefined criterion.

4. The method (600) as claimed in claim 1, further comprising updating a status of the at least one cell in a performance report of the network.

5. The method (600) as claimed in claim 1, wherein the at least one cell belongs to one of following type: a macro cell, a small cell, or a bi-sector antenna.

6. The method (600) as claimed in claim 1, wherein the predefined criterion depends on the type of the at least one cell.

7. The method (600) as claimed in claim 1, wherein the at least one cell and the plurality of neighboring cells belong to a same frequency band.

8. The method (600) as claimed in claim 1, further comprising determining if the at least one cell and the plurality of neighboring cells fulfill a set of network conditions.

9. The method (600) as claimed in claim 8, wherein the set of network conditions includes a network availability and the set of parameters availability of the least one cell and each of the plurality of neighboring cells in the network (106).

10. The method (600) as claimed in claim 9, wherein the set of parameters availability is estimated from a predetermined time period before the at least one cell is added to the network (106) and a second predetermined time period after the at least one cell is added to the network (106).

11. The method (600) as claimed in claim 1, wherein the predefined set of configurations include one or more of remote electrical tilt (RET) parameters or handover parameters related to the first cell.

12. The method (600) as claimed in claim 1, further comprising optimizing a performance of the network based on the modified current configurations of the first cell.

13. The method (600) as claimed in claim 1, wherein the predefined criterion includes at least one value corresponding to each parameter.

14. A system (108) for verification testing of cells in a network (106), the system comprising:
an identification module (208) in a verification testing engine (212), wherein the identification module (208) is configured to:
identify at least one cell added to a database (210) of the network (106);
identify a plurality of neighboring cells associated with the at least one cell;
a processing module (214) in the verification testing engine (212), wherein the processing module (214) is configured to:
obtain a set of parameters for the at least one cell and each of the plurality of neighboring cells from the database (210);
determine if the set of parameters meets a predefined criterion;
when the set of parameters fail to meet the predefined criterion, the processing module (214) configured to perform following steps:
identify, among the at least one cell and the plurality of neighboring cells, a first cell lacking a predefined set of configurations; and
modify a current set of configurations of the first cell based on the predefined set of configurations.

15. The system (108) as claimed in claim 14, wherein the set of parameters include one or more of a session setup success rate, a radio resource control (RRC) connection success rate, and an average received channel quality indicator (CQI).

16. The system (108) as claimed in claim 14, further configured to communicate an alert to a network operator when the set of parameters meets the predefined criterion.

17. The system (108) as claimed in claim 14, further configured to update a status of the at least one cell in a performance report of the network.

18. The system (108) as claimed in claim 14, wherein the at least one cell belongs to one of following type: a macro cell, a small cell, or a bi-sector antenna.

19. The system (108) as claimed in claim 14, wherein the predefined criterion depends on the type of the at least one cell.

20. The system (108) as claimed in claim 14, wherein the at least one cell and the plurality of neighboring cells belong to a same frequency band.

21. The system (108) as claimed in claim 14, further configured to determine if the at least one cell and the plurality of neighboring cells fulfill a set of network conditions.

22. The system (108) as claimed in claim 21, wherein the set of network conditions includes a network availability and the set of parameters availability of the least one cell and each of the plurality of neighboring cells in the network (106).

23. The system (108) as claimed in claim 22, wherein the set of parameters availability is estimated from a predefined time period before the at least one cell is added to the network (106) and a second predefined time period after the at least one cell is added to the network (106).

24. The system (108) as claimed in claim 14, wherein the predefined set of configurations include one or more of remote electrical tilt (RET) parameters or handover parameters related to the first cell.

25. The system (108) as claimed in claim 14, further configured to optimize a performance of the network based on the modified current configurations of the first cell.

26. The system (108) as claimed in claim 14, wherein the predefined criterion includes at least one value corresponding to each parameter.

27. A computer program product comprising a non-transitory computer-readable medium comprising instructions that, when executed by one or more processors, cause the one or more processors to perform a method (600) for verification testing of cells in a network (106), the method comprising:
identifying (602) at least one cell added to a database (210) of the network (106);
identifying (604) a plurality of neighboring cells associated with the at least one cell;
obtaining (606) a set of parameters for the at least one cell and each of the plurality of neighboring cells from the database (210);
determining (608) if the set of parameters meets a predefined criterion;
when the set of parameters fail to meet the predefined criterion, performing following steps:
identifying (610), among the at least one cell and the plurality of neighboring cells, a first cell lacking a predefined set of configurations; and
modifying (612) a current set of configurations of the first cell based on the predefined set of configurations.
